(19) United States
(12) Patent Application Publication
(10) Pub. No.: US 2021/0221126 A1
(43) Pub. Date: Jul. 22, 2021

(54) THERMAL MANAGEMENT OF FLUID EJECTION DEVICES

(71) Applicant: HEWLETT-PACKARD DEVELOPMENT COMPANY, L.P., Fort Collins, CO (US)

(72) Inventors: Eric Martin, Corvallis, OR (US); James Michael Gardner, Corvallis, OR (US); David Maxfield, Corvallis, OR (US)

(73) Assignee: HEWLETT-PACKARD DEVELOPMENT COMPANY, L.P., Fort Collins, CO (US)

(21) Appl. No.: 16/310,922

(22) PCT Filed: Oct. 12, 2016
(86) PCT No.: PCT/US2016/056630

§ 371 Date: Dec. 18, 2018

(51) Int. Cl. B41J 2/045

(52) U.S. Cl. CPC B41J 2/04563; B41J 2/0458

(57) ABSTRACT

In some examples, a control apparatus for thermal management of a fluid ejection device includes a thermal controller to detect a number of a plurality of thermal measurements of the fluid ejection device that exceed a thermal threshold, and in response to determining that the number of thermal measurements that exceed the thermal threshold exceeds a count threshold, deactivating a firing controller of the fluid ejection device.

### BACKGROUND

A printing system can include a printhead that has nozzles to dispense printing fluid to a target. In a two-dimensional (2D) printing system, the target is a print medium, such as a paper or another type of substrate onto which print images can be formed. Examples of 2D printing systems include inkjet printing systems that are able to dispense droplets of inks. In a three-dimensional (3D) printing system, the target can be a layer or multiple layers of build material deposited to form a 3D object.

### BRIEF DESCRIPTION OF THE DRAWINGS

Some implementations of the present disclosure are described with respect to the following figures.

FIG. 1 is a block diagram of a system for use with a fluid ejection device that includes a thermal controller according to some examples.

FIG. 2 is a block diagram of a thermal controller for thermal management of a fluid ejection device according to some examples.

FIG. 3 is a block diagram of a fluid ejection device, according to some examples.

FIG. 4 is a block diagram of a thermal controller for thermal management of a fluid ejection device according to further examples.

FIG. 5 is a flow diagram of a thermal management process for a fluid ejection device, according to some examples.

### DETAILED DESCRIPTION

In the present disclosure, the article “a,” “an”, or “the” can be used to refer to a singular element, or alternatively to multiple elements unless the context clearly indicates otherwise. Also, the term “includes,” “including,” “comprises,” “comprising,” “have,” or “having” is open ended and specifies the presence of the stated element(s), but does not preclude the presence or addition of other elements.

A fluid ejection device, such as a printhead, for use in a printing system can include nozzles that have heating elements, such as firing resistors, that are activated to cause fluid droplets to be ejected from respective nozzles. A heating element when activated generates heat to vaporize a fluid in a firing chamber of a nozzle, which causes expulsion of a droplet of the fluid from the nozzle. A printing system can be a two-dimensional (2D) or three-dimensional (3D) printing system. A 2D printing system dispenses printing fluid, such as ink, to form images on print media, such as paper media or other types of print media. A 3D printing system forms a 3D object by depositing successive layers of build material. Printing fluids dispensed from the 3D printing system can include ink, as well as fluids used to fuse powders of a layer of build material, detail a layer of build material (such as by defining edges or shapes of the layer of build material), and so forth.

Although reference is made to a printhead for use in a printing system in some examples, it is noted that techniques or mechanisms of the present disclosure are applicable to other types of fluid ejection devices used in non-printing applications that are able to dispense fluids through nozzles. Examples of such other types of fluid ejection devices include those used in fluid sensing systems, medical systems, vehicles, fluid flow control systems, and so forth.

During operation of a printhead, excessive heating of the printhead can be a concern. In some examples, excessive heating of the printhead can occur when printing a large number of pages at high speed, or if a supply of printing fluid has become depleted and printing continues. The excessive heating of the printhead can cause damage to the printhead or can cause failure of the printhead during a print operation.

A thermal sensor (or multiple thermal sensors) provided in the printhead to detect temperatures of the printhead can be sensitive to noise of the printhead, such as noise due to switching of power or ground rails of the printhead, operation of high speed circuits on the printhead, rapid switching of high power devices of the printhead, and/or other factors. A printhead can include a printhead die including a substrate on which are arranged nozzles and control circuits, as well as thermal sensor(s). Noise from various sources (such as those listed above) can be coupled to the thermal sensor(s). Noise can cause a thermal sensor to provide a thermal measurement that exceeds a thermal threshold, even though a temperature of the printhead is within an allowable range.

A thermal measurement that exceeds the thermal threshold can trigger activation of a thermal fault system of the printhead. The thermal fault system of the printhead can deactivate a firing controller of the printhead, which can cause the printhead to cease a printing operation. A firing controller of a printhead is used to activate specific nozzles to eject printing fluid droplets from the activated nozzles. Deactivating the firing controller can cause a page being printed to be discarded, or can result in a printing delay.

In accordance with some implementations of the present disclosure, a thermal controller is able to detect a number of multiple thermal measurements that exceed a thermal threshold, and can deactivate a firing controller of a printhead or other fluid ejection device in response to determining that the number of multiple thermal measurements that exceed the thermal threshold exceeds a count threshold. In a noisy operating environment, thermal measurements made in multiple samples can provide a more accurate representation of a temperature of a printhead (or more specifically in some examples, a printhead die) than a single thermal measurement. By considering multiple thermal measurements in triggering deactivation of a printhead (or more specifically, a printhead die), the likelihood of falsely triggering the deactivation of the printhead can be reduced, such that the impact of noise interference with a thermal sensor (or multiple thermal sensors) can be mitigated.

In the ensuing discussion, the term “printhead” can refer generally to a printhead die or an overall assembly that includes multiple printhead dies mounted on a support structure. Moreover, as noted above, the techniques or mechanisms described for use with printheads can also be applied to other types of fluid ejection devices in further examples. A fluid ejection device can be implemented as an integrated circuit (IC) die that includes a substrate on which is provided nozzles and control circuitry to control ejection of a fluid by the nozzles. In other examples, a fluid ejection device can include a structure that has a fluid reservoir containing a fluid, fluid channels connected to the fluid reservoir, and a die or multiple dies including nozzles and control circuitry to control ejection of a fluid by the nozzles.

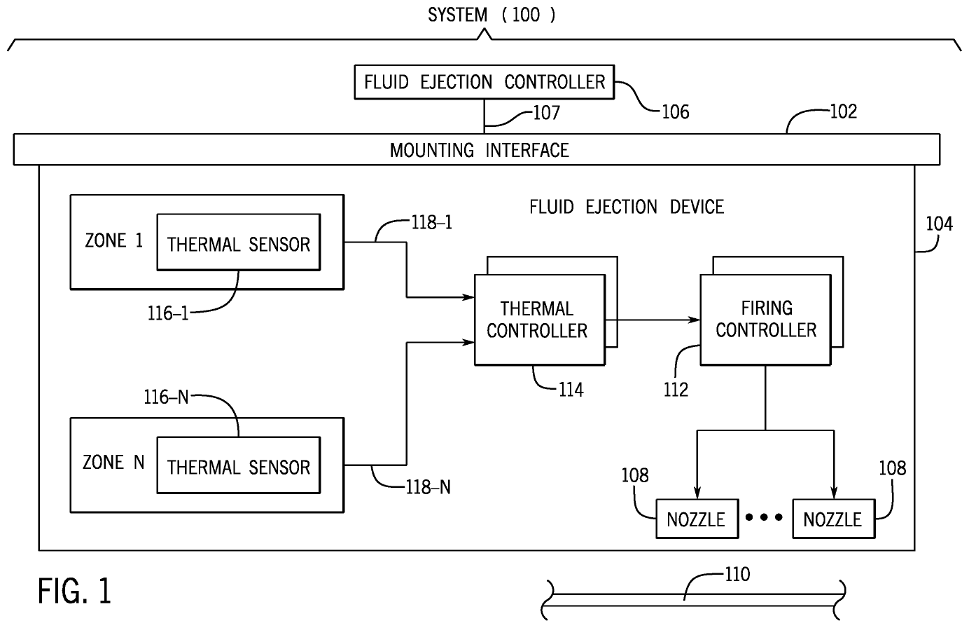

FIG. 1 is a block diagram of an example system 100, which can be a printing system or any other type of fluid ejection system. The system 100 includes a mounting interface 102 to receive a fluid ejection device 104, which can include a printhead, for example. In other examples, the system 100 can have other arrangements.

The mounting interface 102 can include an electrical interface to allow an electronic component in the system 100 to communicate with the fluid ejection device 104. Moreover, in some examples, the mounting interface 102 can include a mechanical mounting structure to mechanically mount the fluid ejection device 104 in the system 100. In some examples, the fluid ejection device 104 can be fixedly attached in the system 100, such as on a carriage of the system 100 that is moveable with respect to a target 112 onto which a fluid is to be deposited. In a 2D printing system, the target 112 includes a print medium such as a paper substrate or another type of substrate onto which an image is to be formed. In a 3D printing system, the target 112 includes a layer of build material (or multiple layers of build material) onto which a printing fluid can be deposited.

In other examples, the fluid ejection device 104 can be removably connected to the mounting interface 102. An example of such a configuration involves use of an integrated printhead that is part of a printing fluid cartridge (e.g., an ink cartridge). With an integrated printhead, a printhead die is attached to the printing fluid cartridge. The printing fluid cartridge is removably mounted in the system 100; for example, the printing fluid cartridge can be removed from the system 100 and replaced with a new printing fluid cartridge.

In yet further examples, a printing system can be a page-wide printing system, where a row of printheads (or printhead dies) can be arranged along the width of a target so that printing fluid can be dispensed simultaneously from the printheads (or printhead dies). More generally, a system can include multiple fluid ejection devices arranged along a line or in an array or any other pattern to dispense fluid to a target.

The system 100 also includes a fluid ejection controller 106 (separate from the fluid ejection device 104) that is used to control fluid ejection operations of the system 100. For example, the fluid ejection controller 106 can be a printer controller that can issue print commands (e.g., in the form of print packets) that are communicated over a communications link 107 to the fluid ejection device 104 (e.g., a printhead) through the mounting interface 102. Each print packet can include address data to address a selected nozzle (or set of nozzles) for firing.

The fluid ejection device 104 includes nozzles 108 which can be selectively activated (fired) to cause ejection of fluid onto the target 110. The firing of the nozzles 108 can be controlled by a firing controller 112. The firing controller 112 can receive control packets (e.g., print packets) from the fluid ejection controller 106 to determine which nozzles 108 is (are) to be fired.

The fluid ejection device 104 also includes a thermal controller 114 according to some implementations of the present disclosure, where the thermal controller 114 is to determine, based on thermal measurements, whether or not to deactivate the fluid ejection device 104, or more specifically, to deactivate the firing controller 112. More specifically, the thermal controller 114 decides whether to deactivate the firing controller 112 based on a determination of whether a number of thermal measurements that exceed the thermal threshold exceeds a count threshold.

In further examples, the fluid ejection device 104 can include multiple firing controllers 112 to control respective multiple collections of nozzles 108. Also, in further examples, the system 100 can include multiple thermal controllers 114, where each thermal controller 114 can control the deactivation of a respective firing controller 112 (or respective firing controllers 112).

As used here, the term “controller” can refer to any or some combination of the following: a microprocessor, a core of a multi-core microprocessor, a microcontroller, a programmable gate array, a programmable integrated circuit device, or any other hardware processing circuit. In further examples, a “controller” can refer to a combination of a hardware processing circuit and machine-readable instructions executable on the hardware processing circuit.

In examples according to FIG. 1, the fluid ejection device 104 includes multiple thermal sensors 116-1 to 116-N, where N 2, which are provided in respective different zones of the fluid ejection device 104, to measure respective temperatures in the corresponding zones. In other examples, the fluid ejection device 104 includes just a single thermal sensor.

The thermal sensors 116-1 to 116-N output respective thermal measurements 118-1 to 118-N to inputs of the thermal controller 114. In some examples, a thermal sensor 116-i (i=1 to N) can be implemented as a thin film sensor resistor or other electrical device, in combination with a resistance sensor to sense the resistance of the sensor resistor. The sensor resistor temperature can be inferred based upon the principle that resistance is proportional to temperature. More generally, the thermal sensor 116-i can provide an analog signal that is proportional to temperature in the respective zone. In further examples, the thermal sensor 116-i can be a temperature sensor to measure an actual temperature of the respective zone of the fluid ejection device. In other examples, a thermal sensor 116-i can output a digital value that represents the temperature of the respective zone. More generally, a thermal sensor 116-i can provide an output in the form of a thermal measurement that is a direct measurement of actual temperature or an indirect measurement of temperature.

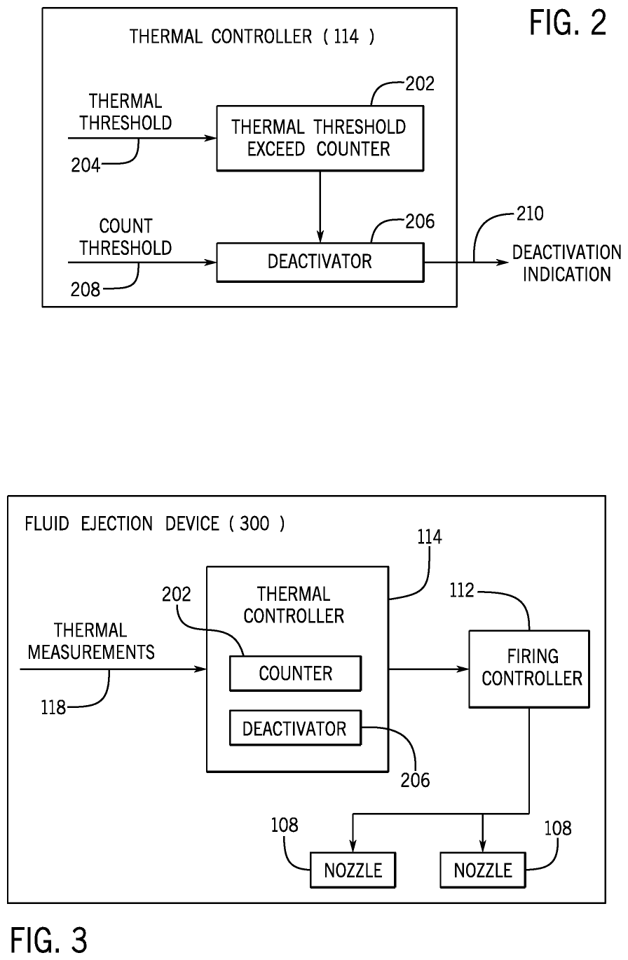

FIG. 2 is a block diagram of an example of the thermal controller 114 according to some implementations of the present disclosure. The thermal controller 114 is part of a control apparatus or device for thermal management of the fluid ejection device 104. The thermal controller 114 includes a thermal threshold exceed counter 202 to detect or track a number of thermal measurements of the fluid ejection device 104 that exceed a thermal threshold 204. More specifically, in some examples, the counter 202 counts a number of consecutive thermal measurements of the fluid ejection device 104 that exceed the thermal threshold 204. The thermal threshold 204 can be a temperature value or another value (e.g., resistance value, electrical voltage value, electrical current value, etc.) that represents temperature.

The consecutive thermal measurements can be from one thermal sensor (e.g., any of thermal sensors 116-1 to 116-N) or from multiple thermal sensors. In examples where the counter 202 counts consecutive thermal measurements from multiple thermal sensors, the counter 202 can advance (either increment or decrement) its value in response to a thermal measurement from any of the thermal sensors that exceeds the thermal threshold 204. As used here, “consecutive thermal measurements” that exceed the thermal threshold 204 can refer to a series of thermal measurements that exceed the thermal threshold 204 without any intervening thermal measurement from any of the thermal sensors that does not exceed the thermal threshold 204.

The thermal controller 114 also includes a deactivator 206. In response to determining that the number of thermal measurements that exceed the thermal threshold 204 (where the number is output from the counter 202) exceeds a count threshold 208, the deactivator 206 deactivates a firing controller (e.g., the firing controller 112 of the fluid ejection device 104). The deactivator 206 is part of a thermal fault system that causes a portion of the fluid ejection device 104 or other fluid ejection device to be deactivated, such that fluid ejection operation by the nozzles 108 (or a subset of the nozzles 108) is stopped.

The deactivator 206 includes a comparator to compare the value of the counter 202 to the count threshold 208. If the count value exceeds the count threshold 208, then the deactivator 206 activates a deactivation indication 210, which can be a signal, a message, an information element, and so forth. The deactivation indication 210 is provided to the firing controller 112 (or multiple firing controllers) to deactivate the firing controller(s).

Depending upon whether the counter 202 increments or decrements in response to a thermal measurement that exceeds the thermal threshold 204, the determination by the deactivator 206 of whether the count value exceeds the count threshold 208 can be a determination of whether the count value is greater than the count threshold 208 or less than the count threshold 208. For example, if the counter 202 decrements with each detection of a thermal measurement that exceeds the thermal threshold, then the count value being less than the count threshold 208 is an indication that a specified number (greater than one) of thermal measurements have been received that exceed the thermal threshold. On the other hand, if the counter 202 increments with each detection of a thermal measurement that exceeds the thermal threshold 204, then the comparator of the deactivator 206 triggers deactivation in response to the count value of the counter 202 being greater than the count threshold 208.

In examples where there are multiple thermal controllers 114, each thermal controller 114 can independently control the deactivation of a respective firing controller 112 based on thermal measurements from a respective subset of thermal sensors 116-i, where the respective subset of thermal sensors can include just a single thermal sensor or can include multiple thermal sensors. For example, a first thermal controller can receive thermal measurements from a first subset of the thermal sensors and control deactivation of a first firing controller based on the thermal measurements from the first subset of thermal sensors, and a second thermal controller can receive thermal measurements from a second subset of thermal sensors and control deactivation of the first firing controller or a second firing controller based on the thermal measurements from the second subset of thermal sensors.

FIG. 3 is a block diagram of a fluid ejection device 300 according to some examples. The fluid ejection device 300 includes the thermal controller 114, the firing controller 112, and the nozzles 108. The thermal controller 114 receives thermal measurements 118, where the thermal measurements can be received from a single thermal sensor or from multiple thermal sensors. The thermal controller 114 provides thermal management of the fluid ejection device 300. The thermal controller 114 includes the counter 202 and the deactivator 206 described above in connection with FIG. 2. The thermal controller 114 is to deactivate the firing controller 112 in response to determining that the number of consecutive thermal measurements that exceed the thermal threshold exceeds the count threshold 208 (FIG. 2).

In some examples, in response to detecting that a thermal measurement does not exceed the thermal threshold 204, the thermal threshold exceed counter 202 is reset to an initial value, such as zero or some other initial low value (in examples where the thermal threshold exceed counter 202 increments). In examples where the thermal threshold exceed counter 202 decrements, the thermal threshold exceed counter 202 is reset to an initial high value.

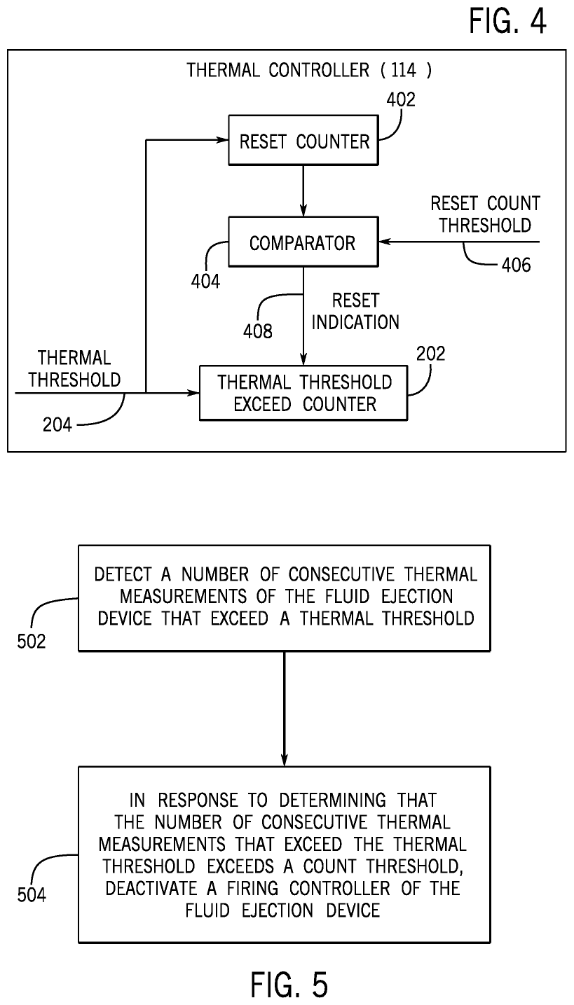

In further examples, as shown in FIG. 4, instead of resetting the thermal threshold exceed counter 202 in response to detection of a single thermal measurement that does not exceed the thermal threshold 204, the thermal controller 114 includes a reset counter 402 that counts or tracks a number of consecutive thermal measurements that do not exceed the thermal threshold 204. The reset counter 402 advances (increments or decrements) with each thermal measurement that does not exceed the thermal threshold 204. In response to a thermal measurement that exceeds the thermal threshold 204, the reset counter 402 is reset to an initial value.

The thermal controller 114 of FIG. 4 further includes a comparator 404 that compares a reset count value (which is the current value of the reset counter 402) with a reset count threshold 406. If the reset count value exceeds the reset count threshold 406, the comparator outputs a reset indication 408 (which can be a signal, a message, an information element, and so forth). A reset count value exceeding the reset count threshold 406 can refer to either the reset count value being greater than the reset count threshold 406 or being less than the reset count threshold 406, depending upon whether the reset counter 402 increments or decrements.

The reset indication 408 causes a reset of the thermal threshold exceed counter 202 to the initial value of the thermal threshold exceed counter 202.

FIG. 5 is a flow diagram of an example process of thermal management of a fluid ejection device, according to some examples. The process includes detecting (at 502) a number of consecutive thermal measurements of the fluid ejection device that exceed a thermal threshold. In response to determining that the number of consecutive thermal measurements that exceed the thermal threshold exceeds a count threshold, the process deactivates (at 504) a firing controller of the fluid ejection device.

Various components described in this disclosure, such as the thermal controller 114 or components within the thermal controller 114, including the thermal threshold exceed counter 202 of FIG. 2, 3, or 4, the deactivator 206 of FIG. 2 or 3, the reset counter 402 of FIG. 4, or the comparator 404 of FIG. 4, can be implemented using a hardware processing circuit, or alternatively, as a combination of a hardware processing circuit and machine-readable instructions executable on the hardware processing circuit.

In examples where machine-readable instructions are used, the machine-readable instructions can be stored in a non-transitory computer-readable or machine-readable storage medium. The storage medium can be implemented using a memory including one or any combination of the following: a semiconductor memory device such as dynamic or static random access memory (DRAM or SRAM), an erasable and programmable read-only memory (EPROM), an electrically erasable and programmable read-only memory (EEPROM), and a flash memory; a magnetic disk such as fixed, floppy and removable disk; or another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A control apparatus for thermal management of a fluid ejection device, comprising:
a thermal controller to:
detect a number of a plurality of thermal measurements of the fluid ejection device that exceed a thermal threshold; and
in response to determining that the number of thermal measurements that exceed the thermal threshold exceeds a count threshold, deactivate a firing controller of the fluid ejection device.

2. The control apparatus of claim 1, wherein the thermal controller comprises a counter to track the number of the plurality of thermal measurements that exceed the thermal threshold.

3. The control apparatus of claim 2, wherein the thermal controller is to reset the counter in response to a thermal measurement that does not exceed the thermal threshold.

4. The control apparatus of claim 3, wherein the thermal controller is to reset the counter in response to detecting that a number of thermal measurements that do not exceed the thermal threshold exceeds a reset count threshold.

5. The control apparatus of claim 4, wherein the thermal controller comprises a reset counter that tracks the number of thermal measurements that do not exceed the thermal threshold.

6. The control apparatus of claim 1, wherein the number of the plurality of thermal measurements of the fluid ejection device that exceed the thermal threshold comprises a number of consecutive thermal measurements of the fluid ejection device that exceed the thermal threshold.

7. The control apparatus of claim 1, further comprising:
a thermal sensor to detect a temperature of the fluid ejection device and to output the thermal measurements based on the temperature.

8. The control apparatus of claim 1, further comprising:
a plurality of thermal sensors to detect temperatures in respective zones of the fluid ejection device and to output the thermal measurements based on the temperatures.

9. The control apparatus of claim 8, wherein the thermal controller is a first thermal controller to perform the detecting and the deactivating based on thermal measurements from a first subset of the plurality of thermal sensors, the control apparatus further comprising:
a second thermal controller to:
detect a number of a plurality of thermal measurements from a second subset of the plurality of thermal sensors that exceed a thermal threshold; and
in response to determining that the number of thermal measurements from the second subset of the plurality of thermal sensors that exceed the thermal threshold exceeds the count threshold, deactivating the firing controller.

10. A fluid ejection device comprising:
nozzles to dispense a fluid onto a target;
a firing controller to control firing of the nozzles; and
a thermal controller to provide thermal management of the fluid ejection device, the thermal controller comprising a counter to track a number of consecutive thermal measurements of the fluid ejection device that exceed a thermal threshold, the thermal controller to deactivate the firing controller in response to determining that the number of consecutive thermal measurements that exceed the thermal threshold exceeds a count threshold.

11. The fluid ejection device of claim 10, comprising a plurality of zones and respective thermal sensors in the plurality of zones, the thermal controller to receive the thermal measurements from the thermal sensors.

12. The fluid ejection device of claim 10, comprising a plurality of zones and respective thermal sensors in the plurality of zones, wherein the thermal controller is a first thermal controller to receive thermal measurements from a first subset of the thermal sensors, the fluid ejection device further comprising:
a second thermal controller comprising a counter to track a further number of consecutive thermal measurements from a second subset of the thermal sensors that exceed the thermal threshold, the second thermal controller to deactivate the firing controller or another firing controller in response to determining that the further number of consecutive thermal measurements that exceed the thermal threshold exceeds the count threshold.

13. The fluid ejection device of claim 10, wherein the thermal controller is to reset the counter in response to detecting a thermal measurement that does not exceed the thermal threshold.

14. A method of thermal management of a fluid ejection device, comprising:
detecting a number of consecutive thermal measurements of the fluid ejection device that exceed a thermal threshold; and
in response to determining that the number of consecutive thermal measurements that exceed the thermal threshold exceeds a count threshold, deactivating a firing controller of the fluid ejection device.

15. The method of claim 14, wherein the detecting is based on a value of a counter that tracks a number of consecutive thermal measurements of the fluid ejection device that exceed the thermal threshold, the method further comprising:
resetting the counter in response to detecting a thermal measurement of the fluid ejection device that does not exceed the thermal threshold.
